(19) United States
(12) Patent Application Publication
(10) Pub. No.: US 2001/0009863 A1
(43) Pub. Date: Jul. 26, 2001

(54) Method for restricting an incoming call in a telecommunication unit

(75) Inventor: Yang-Sun Kim, Taejeon-Kwangyokshi (KR)

Correspondence Address: Paul J. Farrell Esq, DILWORTH & BARRESE, 333 Earle Ovington Boulevard, Uniondale, NY, 11553, US

(73) Assignee: Samsung Electronics Co.

(21) Appl. No.: 09/737,135

(22) Filed: Dec. 14, 2000

(30) Foreign Application Priority Data
Dec. 14, 1999 (KR) P1999-57398

(51) Int. Cl. H04B 1/38

(52) U.S. Cl. 455/567; 455/1

(57) ABSTRACT

A method for processing a calling message in a telecommunication system to restrict calls incoming through a telecommunication unit during a particular period of time. The method includes the steps of implementing a setting mode to reject calls incoming during the particular period of time, setting a rejection mode of incoming calls by inputting said particular period of time; detecting whether or not said rejection mode of incoming calls has been set if there is a call after said setting of the rejection; detecting whether or not the present time falls within the set particular period of time if said rejection mode of incoming calls has been set; and avoiding an incoming call if the call is made during said particular period of time.

### PRIORITY

This application claims priority to an application entitled “Method for Restricting Incoming Call in Telecommunication Unit” filed with the Korean Industrial Property Office on Dec. 14, 1999 and assigned Ser. No. 99-57398, the contents of which is hereby incorporated by reference.

### BACKGROUND OF THE INVENTION

1. Field of the Invention

The present invention relates to processing of calls received in a telecommunication system, and more particularly to a method for restricting incoming calls in accordance with the will of a user.

2. Description of the Related Art

With the increasing and widespread use of mobile telecommunication units, noise pollution has become prevalent in public places. For instance, the ringing of a bell of a mobile telecommunication unit in places requiring silence, such as for example during stage performances, at theaters, courts or libraries, causes discomfort and irritation to the public and may hinder performances. Therefore, a majority of mobile telecommunication unit users either turn off the power or shift the mode of their phones to a vibration mode or some sort of silence mode when entering places such as theaters, courts or libraries. However, this requires cumbersome processes by the user, including re-shifting the mode of their phones to an ordinary bell once after leaving their seats at those public places.

There exist ways of rejecting incoming calls by using a call barring function in a telecommunication system, such as, for example in a global system for mobile (GSM) telecommunication system. The call barring function generally provides the user with one of the following menus: “All Outgoing” for restricting all outgoing calls; “International” for restricting international calls; “International Except to Home” for restricting international calls except calls directed to a subscriber's home country; “Incoming while abroad” for rejecting calls from overseas; “Cancel All” for canceling the services subscribed to date; and “All Incoming” for interrupting all incoming calls. The following table briefly shows network service menus in a conventional GSM telecommunication system.

TABLE 1

| | | |
|---|---|---|
| Network Service | Call Diverting | |
| | Call Barring | All Outgoing |
| | | International |
| | | International Except to |
| | | Home |
| | | Incoming While Abroad |
| | | Cancel All |
| | | All Incoming |
| | CUG | |

Therefore, all incoming calls can be rejected at the subscriber's will by availing the “All Incoming” call barring function. Moreover, the services of the above function are typically provided during a particular period of time. Thus, rejections of the calls cannot be provided as desired after the service time is over. Therefore, in order to cancel the subscription after the service time is over and newly subscribe to the above function again, the subscriber needs to request cancellation of the subscription in the name of a business entity conducting a certain kind of services.

Table 2 briefly illustrates a flow of control over subscription of the above services in a mobile telecommunication unit through a network.

TABLE 2

| Step | Phone | Message | Network |
|---|---|---|---|
| 1 | Outgoing | Register | Incoming |
| 2 | Outgoing | Facility | Incoming |
| | | (INVOKE = | |
| | | ActiveSS (SS-code, | |
| | | Basic Service Code) | |
| 3 | Outgoing | Password Procedure | Incoming |
| | | according to TS | |
| | | GSM 04.10 | |
| 4 | Incoming | Release Complete | Outgoing |
| | | Facility (Return | |
| | | Result = ActivateSS | |
| | | (SS-code, Basic | |
| | | Service Code, SS- | |
| | | Status)) | |
| 5 | Incoming | Release Complete | Outgoing |
| | | Facility (Return error | |
| | | (Error)) | |
| 6 | Incoming | Release Complete | Outgoing |
| | | Facility (Reject | |
| | | (Invoke problem)) | |

Since the operational flow according to the Table 2 appears in the specification for GSM, a detailed explanation thereof will be omitted here. In order to set the call barring function for the “All Incoming,” the subscriber needs to input his/her own password through the network as shown in Step 3 of the Table 2. Also, no service is provided if the subscriber is no longer a current subscriber or if any error occurs in the link (Steps 5 and 6). Accordingly, the subscriber needs to attempt a re-connection to the call or confirm the reason for unavailability of the services.

### SUMMARY OF THE INVENTION

It is, therefore, an object of the present invention to provide an easily implemented method for restricting incoming calls in a telecommunication unit during a particular duration of time.

It is another object of the present invention to provide a method for rejecting incoming calls in a telecommunication unit during a particular duration of time without a subscription of services through the network.

It is still another object of the present invention to provide a method for rejecting incoming calls in a telecommunication unit during a particular duration of time through the network.

To achieve the above objects, there is provided a method for rejecting incoming calls in a telecommunication unit during a particular duration of time, comprising: a setting step to implement a setting mode for rejecting incoming calls during a particular duration of time, and for setting a rejection mode for rejecting incoming calls by inputting the particular period of time during which calls will be rejected; and an implementing step to detect setting of the rejection mode for the incoming calls whether or not the rejection mode of the incoming calls has been duly set if there is an incoming call after undergoing the setting step, as well as to detect if the present time falls within the set particular duration or period of time, and to not respond to the incoming call if the present time falls within the set particular period of time.

### BRIEF DESCRIPTION OF THE DRAWINGS

The above and other objects, features and advantages of the present invention will become more apparent from the following detailed description when taken in conjunction with the accompanying drawings, in which:

FIG. 1 is a block diagram illustrating the construction of a mobile telecommunication unit according to an example of the present invention;

FIG. 2 is a flow chart of the control over restricting calls in a mobile telecommunication unit according to an example of the present invention; and

FIG. 3 is a flow chart of the control over restricting calls in a mobile telecommunication unit according to another example of the present invention.

### DETAILED DESCRIPTION OF THE PREFERRED EXAMPLE

A preferred embodiment of the present invention will be described herein below with reference to the accompanying drawings. In the following description, well-known functions or constructions are not described in detail since they would obscure the invention in unnecessary detail.

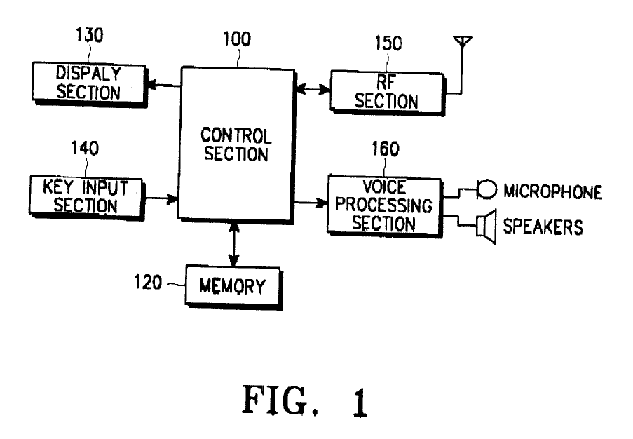

FIG. 1 is a block diagram illustrating the construction of a mobile telecommunication unit according to an example of the present invention. Referring to FIG. 1, a control section 100 controls an overall operation of the mobile telecommunication unit as well as the operation for rejecting incoming calls according to a preferred example of the present invention. When referring to “rejecting” calls, it is to be understood that the terms “restricting”, “blocking”, “diverting”, “avoiding a call” and similar terms equally apply and are contemplated by the present invention. A key input section 140 comprises a plurality of Arabic numbers and letters, function keys (FCN), storage keys (STO), volume down/up keys, navigation keys (in vertical and horizontal directions), etc., and generates key data for the above keys. A memory 120 temporarily stores predetermined operational programs and data generated in the course of implementing the operational programs. A display section 130 displays diverse kinds of information including data inputted from the key input section 140 and the operational status of the unit. An RF section 150 performs modulation/demodulation by amplifying and filtering signals incoming and outgoing through antenna ANT. A voice processing section 160 processes and digitizes a voice inputted to a microphone 170 under control of control section 100, and modulates voice data received from the RF section 150 to output the modulated voice data through speakers 180.

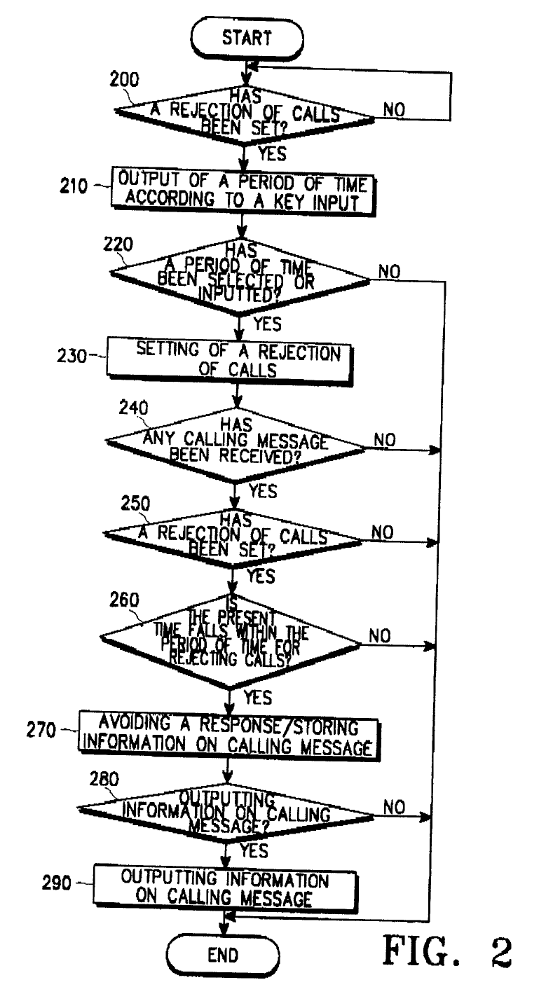

An operation of the method for restricting incoming calls according to a preferred embodiment of the present invention will now be described in further detail with reference to FIGS. 1 and 2.

In step 200, the control section 100 detects whether or not a key for implementing a setting mode for not responding to incoming calls during a particular duration of time is inputted from the key input section 140 by a key input by a user. Detection is accomplished by checking memory 120. If the key is inputted, the process proceeds to step 210, and a particular time frame is outputted in accordance with the key input. If the rejection mode has not been set, the process returns to START. In this embodiment, the time frames are preset in various increments of time. It is of course contemplated that the user can input his/her own time frame, so that he/she is not limited to the preset time frames. Table 3 below shows examples of the output of a particular time frame.

TABLE 3

| Key Input | Example of the Display |
|---|---|
| [symbol] | 30 Minutes |
| [symbol] [symbol] | 1 Hour |
| [symbol] [symbol] [symbol] | 2 Hours |
| [symbol] [symbol] [symbol] [symbol] | 3 Hours |
| [symbol] [symbol] [symbol] [symbol] [symbol] | 4 Hours |
| [symbol] [symbol] [symbol] [symbol] [symbol] [symbol] | Cancel |
| [symbol] [symbol] [symbol] [symbol] [symbol] [symbol] [symbol] | 30 Minutes |

With reference to Table 3, the control section 100 toggles and displays the particular time frame according to the user's input of the “ [symbol] ” button.

In step 220, the control section 100 proceeds to step 230 if a predetermined period of time has been inputted through toggling and displaying, and sets a rejection mode of incoming calls and will store a set value (see Table 4 below) in a particular region of the memory 120. It is to be understood that the display can be in military time or standard time. If the time frame has not been selected (inputted), the process returns to step 200.

TABLE 4

| Setting | Starting Time | Ending Time | Repeat |
|---|---|---|---|
| 0 | 10:00, Nov. 11, 1999 | 13:00, Nov. 11, 1999 | Once |

The input of the predetermined period of time is as follows, as shown in Table 5:

TABLE 5

| Starting Time | Ending Time |
|---|---|
| 10:00, Nov. 11, 1999 | 13:00, Nov. 11, 1999 |

If the user has selected the value that is toggled and displayed, the period of time is from the point of time when the rejection mode was set until the terminating or ending point of the selected time period. For example, if the user selected one hour, and the present time is 9:00, Nov. 11, 1999, the following will be the period of time, as shown in Table 6.

TABLE 6

| Starting Time | Ending Time |
|---|---|
| 9:00, Nov. 11, 1999 | 10:00, Nov. 11, 1999 |

Accordingly, if a period of time has been set by the value that is toggled and displayed, the result is as shown in Table 5 above. The setting of time may be made once, on a daily basis or on a weekly basis. This means that the calls can be rejected during the same period of time every day or during a particular period of time on a particular day every week.

If the rejection mode has been set in step 230, the control section 100 detects whether or not a calling message is received at step 240. If so, the process proceeds to step 250 and the control section 100 further detects whether or not a rejection mode has been set. If not, the process ends.

If the rejection mode has been set, the process proceeds to step 260 so as to detect whether or not the present time falls within the period of time set for rejecting the calls. If not, the process ends. If the call has been received during the period of time set for rejecting the calls, the process proceeds to step 270, and a signal is sent to the base station so that the base station does not transfer an acknowledging message to the base station and the call does not go through, and the phone does not ring. The control section 100 analyzes the calling message and stores the calling information in the memory 120. The data stored in the memory 120 may include the calling time and telephone number of the calling person.

After storing the call information at step 270, the process proceeds to step 280 to detect whether or not the user has requested an output of the calling information after the time set for the rejection mode has elapsed. If the user has made such a request, the calling message stored in the memory 120 is read out and displayed on the display section 130. If no such request was made, the process ends.

Table 7 shows a set menu according to the process of FIG. 2.

TABLE 7

| | |
|---|---|
| Call Barring | All Outgoing |
| | International |
| | International Except to Home |
| | All Incoming While Abroad |
| | Cancel All |
| | All Incoming |

| | | |
|---|---|---|
| Time Setting | Daily | Not Set |
| | Weekly | Not Set |
| | Once | Set |

Table 8 below shows an example of setting the period of time based on a sleep & time setting mode.

TABLE 8

| | | | | | | | | | | | | |
|---|---|---|---|---|---|---|---|---|---|---|---|---|
| | | Number of | | | | | | | | | | |
| Call | | Key [symbol] Input | 1 | 2 | 3 | 4 | 5 | | 7 | 8 | 9 | 10 |
| Rejection | Sleep | | 30 | 1 | 2 | 3 | 4 | 6 | 30 | 1 | 2 | 3 |
| Mode | Mode | | Min. | Hr. | Hrs. | Hrs. | Hrs. | Cancel | Min. | Hr. | Hrs. | Hrs. |

| | | |
|---|---|---|
| Time Setting | Daily | Not Set |
| | Weekly | Not Set |
| | Once | Set |

An operation of the first embodiment of the present invention will now be briefly described with reference to FIG. 2.

Once after the user inputted a period of time for rejecting calls, and if there has been any calls during the pertinent period of time, the telecommunication unit will not vibrate, ring or become lightened, and no response message will be transferred to the base station. The call information, for example telephone number and call time, may be stored in memory. If the user later requests output of the calling information, the stored calling information will be outputted. Such an operation can be performed irrespective of the particular network to which the user subscribes.

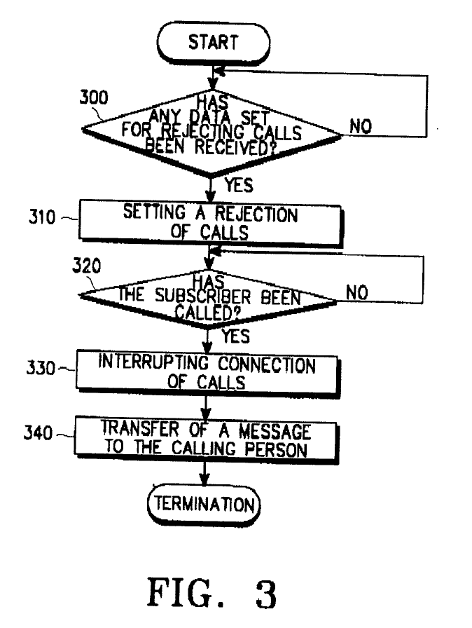

An operation of a second embodiment of the present invention will now be described with reference to FIGS. 1 and 3. FIG. 3 shows an operation of call rejection by the network.

In step 300, the network detects whether or not any data set for rejection of calls have been received. This set data may be collected and transferred by the user of the telecommunication unit, and may include voice messages inputted through a voice mail system. The set data includes information on the period of time for rejecting the calls as well as information concerning the user or subscriber of the system. If such data has been received, the process proceeds to step 310. If not, the process returns to START.

In step 310, the network sets the telecommunications unit to a rejection mode, and the process proceeds to step 320. In step 320, the network detects whether or not there has been any calls directed to the subscriber. If so, the process proceeds to step 330. If not, the process stays at step 320 until the subscriber is called or the rejection mode is abandoned. In step 330, the network discontinues the usual procedure of connecting the calls, and notifies the calling person of a rejection of his/her call in step 340. At this point, the call information may be stored in memory 120.

As described above, the present invention provides an advantage of rejecting calls incoming through a telecommunication unit during a particular period of time even without a request being made for this service to the network. The present invention also enables the user to easily set a rejection of incoming calls mode by using a toggle in setting the period of time for rejection.

While the invention has been shown and described with reference to a certain preferred embodiment thereof, it will be understood by those skilled in the art that various changes in form and detail may be made therein without departing from the spirit and scope of the invention as defined by the appended claims.

What is claimed is:

1. A method for rejecting incoming calls in a telecommunication system during a predetermined period of time, comprising the steps of:
entering a setting mode to reject incoming calls during said predetermined period of time;
setting a rejection mode of incoming calls by inputting said predetermined period of time during said setting mode;
detecting whether or not said rejection mode of incoming calls has been set during an incoming call;
detecting whether or not the present time falls within said input predetermined period of time if said rejection mode of incoming calls has been set; and
avoiding said incoming call if the present time falls within said predetermined period of time.

2. The method of claim 1, wherein said predetermined period of time is inputted by a user through selection of a time period displayed in a menu by toggling according to a key input.

3. The method of claim 1, wherein said predetermined period of time is set from a point in time that a selection on a menu is made until a point in time selected by the user from the menu according to a key input by the user.

4. The method of claim 1, wherein said rejection mode of incoming calls is set according to one of a one-time basis, a daily basis or a weekly basis.

5. The method of claim 1, further comprising a step of storing information on incoming calls, and outputting stored information on incoming calls after said predetermined period of time has elasped.

6. A method for rejecting calls incoming to a telecommunication unit during a predetermined period of time in a telecommunication system, the telecommunication unit including a key input section and a display, comprising the steps of:
entering a setting mode to reject incoming calls during a predetermined period of time;
displaying a period of time menu;
toggling and outputting a period of time from said menu to reject said calls based on a value inputted by a user through a key input from said key input section during said setting mode;
setting said predetermined period of time in a rejection mode for rejecting incoming calls according to the time frame selected by the user;
detecting whether or not said predetermined period of time has elapsed;
avoiding incoming calls during said predetermined of time if said predetermined period of time has not elapsed; and
canceling said rejection mode if said predetermined period of time has elapsed, and entering a normal operation mode.

7. A method for rejecting incoming calls to a telecommunication unit during a predetermined period of time, comprising the steps of.
receiving information from a user to reject incoming calls during a predetermined period of time and receiving set data including the information regarding said predetermined period of time;
setting a call rejection mode based on the received set data; and
transferring a message to a calling person without connecting the call that the call has been rejected by the user if the call incoming to the user was made during the predetermined period of time.
